(19) United States
(12) Patent Application Publication
(10) Pub. No.: US 2020/0233367 A1
(43) Pub. Date: Jul. 23, 2020

(54) IMAGE FORMING APPARATUS WITH WASTE TONER MANAGEMENT

(71) Applicant: TOSHIBA TEC KABUSHIKI KAISHA, Tokyo (JP)

(72) Inventor: Tadashi SUGIYAMA, Numazu Shizuoka (JP)

(73) Assignee: TOSHIBA TEC KABUSHIKI KAISHA, Tokyo (JP)

(21) Appl. No.: 16/255,550

(22) Filed: Jan. 23, 2019

(51) Int. Cl. G03G 21/10; G03G 15/00

(52) U.S. Cl. CPC G03G 21/105; G03G 15/5016

(57) ABSTRACT

According to one embodiment, an image forming apparatus includes a waste toner box, a stirring member, a rotation speed detector, and a rotation time corrector. The waste toner box collects unused part of toner supplied for printing, an adjustment operation, or the like. The stirring member is configured to be rotated to stir the toner in the waste toner box. The rotation speed detector detects a rotation speed of the stirring member. The rotation time corrector corrects a set rotation time based on the rotation speed detected by the rotation speed detector and a set rotation speed of the stirring member which is set in advance.

### FIELD

Embodiments described herein relate generally to an image forming apparatus.

### BACKGROUND

In a multi-functional image forming apparatus (for example, a multi-functional peripheral (MFP)) of the related art, part of toner remaining when an output image is formed using the toner is collected as waste toner in a waste toner collection container. A stirring paddle is rotatably installed in the waste toner collection container of a toner storage device. The stirring paddle transfers the collected waste toner evenly under a set rotation condition.

Thus, for example, when the number of rotations of the stirring paddle is extremely large (i.e., corresponding to a high rate of rotation), whether the waste toner collection container is full of the waste toner is detected prematurely due to high resistant forces associated with the high rate of rotation and thus the amount of the waste toner to be stored in one waste toner collection container is less than its actual capacity. By contrast, when the number of rotations of the stirring paddle is extremely small (i.e., corresponding to a low rate of rotation), the waste toner cannot be sufficiently transferred into the waste toner collection container and thus the inside of each cleaner can be clogged with the waste toner.

When the amount of the waste toner in the waste toner collection container increases, the load torque of the stirring paddle increases. When the load torque of the stirring paddle exceeds a predetermined upper limit, the coupling for drive transmission is separated from a full level detection and drive mechanism with a motor. When the coupling is separated, a driving force of the motor is not transferred to the stirring paddle located in the waste toner collection container. In this case, the stop of the rotation of the stirring paddle is detected by a photosensor, and the waste toner storage box is determined to be full.

Meanwhile, a DC brush motor may be used as a motor of the stirring paddle. A rotation speed of the DC brush motor is likely to vary due to its structure. Accordingly, in the image forming apparatus of the related art, the number of rotations of the stirring paddle may fluctuate due to a variation in the rotation speed of the motor and an increase or decrease in the load torque. Thus, it is difficult to appropriately collect the waste toner.

### DESCRIPTION OF THE DRAWINGS

FIG. 1 is a schematic view illustrating a configuration of an image forming apparatus according to an embodiment;

FIG. 2 is a schematic view illustrating a configuration of an image former;

FIG. 3 is a schematic view illustrating a configuration of a toner storage device;

FIG. 4 is a view illustrating a driving mechanism of the toner storage device;

FIG. 5 is a diagram illustrating a functional configuration of the toner storage device;

FIG. 6 is a diagram illustrating a controller of the toner storage device; and

FIG. 7 is a flowchart illustrating correcting a set rotation time of the toner storage device.

### DETAILED DESCRIPTION

In general, according to one embodiment, an image forming apparatus includes a waste toner box, a stirring member, a rotation speed detector, and a rotation time corrector. The waste toner box collects, as waste toner, toner which is not transferred. The toner in the waste toner box is stirred through rotation of the stirring member. The rotation speed detector measures the rotation speed of the stirring member. The rotation time corrector corrects a set number of rotations based on the relationship between the rotation speed measured by the rotation speed detector and a set rotation speed of the stirring member which is set in advance.

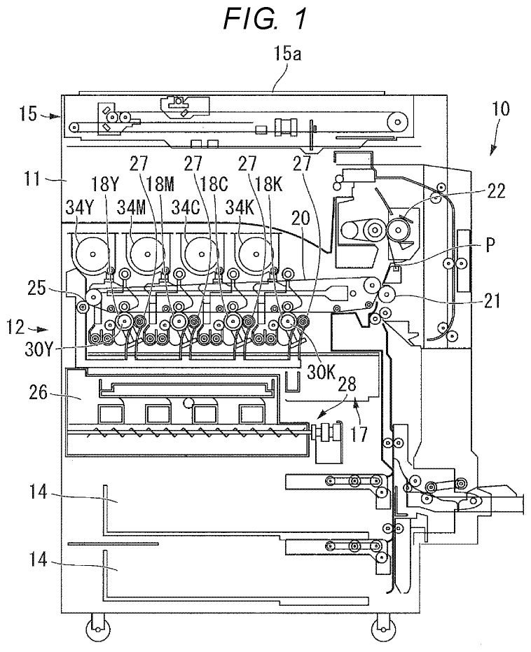

Hereinafter, a toner storage device 26 of an image forming apparatus 10 according to an embodiment will be described with reference to the drawings. For clarity, in FIGS. 1 to 6, a size and shape of each component are exaggerated or simplified. FIG. is a schematic cross-sectional view of an example of a configuration of the image forming apparatus 10 according to an embodiment.

The image forming apparatus 10 according to the embodiment is, for example, a digital multi-functional peripheral (MFP), a printer, a copy machine or the like, in which a color electrophotographic apparatus is used. An example in which the image forming apparatus 10 is an MFP will be described below.

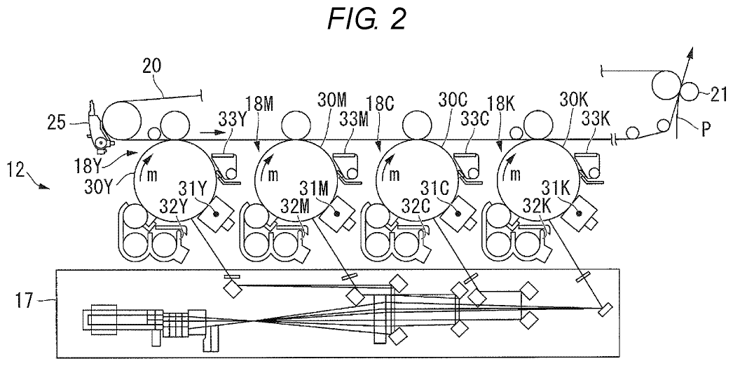

In FIGS. 1 and 2, a device main body 11 of the image forming apparatus 10 includes an image former 12 at a center part thereof in a longitudinal direction. The device main body 11 includes, as a sheet storage unit 13, paper feed cassettes 14 and a manual feed tray below the image former 12. The number of the paper feed cassettes 14 may be an appropriate number which is equal to or greater than 1. In the example of FIG. 1, two sets of the paper feed cassettes 14 are arranged. The device main body 11 includes the toner storage device 26 between the image former 12 and the paper feed cassettes 14. The device main body 11 includes an image reader 15 above the image former 12.

The image former 12 forms a visible image corresponding to image data on sheet P such as paper or a resin sheet. The image data may be, for example, data generated by the image reader 15 or data supplied from outside. The data supplied from outside may be data supplied from a storage medium such as a semiconductor memory or may be supplied via a network.

The image reader 15 obtains characters or an image of an object to be read in the form of the brightness or darkness of light, and generates image data corresponding to the brightness or darkness of the light. The image reader 15 includes an original document table 15a, and an image sensor, such as a CCD sensor, which converts image information into an image signal. The image reader 15 converts reflected light obtained by emitting light from an illumination device onto an original document supported by the original document table 15a into an image signal using the CCD sensor.

The image former 12 includes an exposure device 17, and image forming stations 18Y, 18M, 18C, and 18K forming first to fourth single-color visible image formers. Further, the image former 12 includes an intermediate transfer belt 20 as a primary transfer unit, a sheet transfer device 21 as a secondary transfer unit, and a fixing device 22. The image former 12 includes an intermediate transfer belt cleaner 25 and photoconductive drum cleaners 33Y, 33M, 33C, and 33K to collect waste toners not used for printing. The waste toner is collected in the toner storage device 26 via a waste toner collection mechanism 27. A full level detection and drive mechanism 28 is installed in the toner storage device 26.

The image former 12 will be described with reference to FIG. 2 below. Each of the single-color image forming stations 18Y, 18M, 18C, and 18K form visible images of respective cyan (C), magenta (M), yellow (Y), and black (K). The arrangement of the image forming stations 18Y, 18M, 18C, and 18K, that is, the order of the colors is determined according to an image forming process and characteristics of toner.

The image forming stations 18Y, 18M, 18C and 18K include photoconductive drums 30Y, 30M, 30C and 30K. Electrification chargers 31Y, 31M, 31C, and 31K and developing devices 32Y, 32M, 32C, and 32K are arranged around the photoconductive drums 30Y, 30M, 30C, and 30K in a rotating direction m of the photoconductive drums 30Y, 30M, 30C, and 30K. Furthermore, the intermediate transfer belt 20 is in contact with the photoconductive drums 30Y, 30M, 30C, and 30K. The photoconductive drum cleaners 33Y, 33M, 33C, and 33K are arranged to the photoconductive drums 30Y, 30M, 30C, and 30K at a downstream side of the intermediate transfer belt 20. Exposure light from the exposure device 17 is emitted between the electrification chargers 31Y, 31M, 31C, and 31K and the developing devices 32Y, 32M, 32C, and 32K of the photoconductive drums 30Y, 30M, 30C, 30K.

The exposure device 17 converts the image data into an intensity of light and emits the light to the photoconductive drums 30Y, 30M, 30C, and 30K. As a result, a latent image corresponding to the exposure light is formed on the respective photoconductive drums 30Y, 30M, 30C, and 30K. Toner images (visible images) held on the photoconductive drums 30Y, 30M, 30C, and 30K are primarily transferred to the intermediate transfer belt 20. The intermediate transfer belt 20 holds and transfers the toner images formed by each of the image forming stations 18Y, 18M, 18C, and 18K.

The developing devices 32Y, 32M, 32C, and 32K detect toner density by a density sensor. Toners of yellow Y, magenta M, cyan C, and black K are supplied to the developing devices 32Y, 32M, 32C, and 32K from toner cartridges 34Y, 34M, 34C, and 34K which are suppliers. Thus, the toner density is maintained constant by the developing devices 32Y, 32M, 32C, and 32K. The developing devices 32Y, 32M, 32C, and 32K supply the toner to the latent image held by the photoconductive drums 30Y, 30M, 30C, and 30K to develop the latent image.

The sheet transfer device 21 transfers the toner image transferred by the intermediate transfer belt 20 to the sheet P as secondary transfer images. The fixing device 22 fixes the toner image, transferred to the sheet P from the intermediate transfer belt 20 by the sheet transfer device 21, onto the sheet P.

Part of the toner supplied from the developing devices 32Y, 32M, 32C, and 32K does not move from the photoconductive drums 30Y, 30M, 30C, and 30K to the intermediate transfer belt 20. The part of the toner is transfer residual toner remaining on the photoconductive drums 30Y, 30M, 30C, and 30K. The transfer residual toner is removed by the photoconductive drum cleaners 33Y, 33M, 33C, and 33K respectively, and collected in the toner storage device 26 from the waste toner collection mechanism 27.

At the intermediate transfer belt 20, the toner images are secondarily transferred to the sheet P by the sheet transfer device 21. Transfer residual toner that does not move to the sheet P from the intermediate transfer belt 20 is collected in the toner storage device 26 by the intermediate transfer belt cleaner 25. The toner storage device 26 collects the transfer residual toner via the waste toner collection mechanism 27.

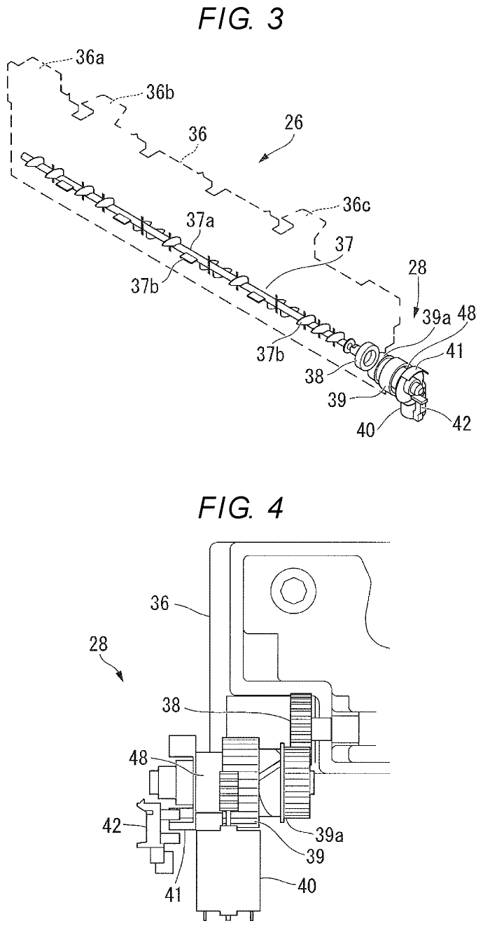

Referring to FIGS. 3 and 4, the toner storage device 26 includes a waste toner box 36 and the full level detection and drive mechanism 28. In the waste toner box 36, a stirring paddle 37 is provided in a lengthwise direction thereof. The stirring paddle 37 is included in a stirring member. The stirring paddle 37 includes a rotatable paddle rotation shaft 37a and a plurality of paddles 37b sequentially fixed along the paddle rotation shaft 37a. The paddles 37b are arranged with a certain interval at different angles in an axial direction of the paddle rotation shaft 37a.

The full level detection and drive mechanism 28 is installed at one end of the stirring paddle 37. The full level detection and drive mechanism 28 includes a paddle drive gear 38 provided at one end of the paddle rotation shaft 37a, a shaft part 48 including a drive transmission gear 39, and a motor 40. The motor 40 is a driving source of the stirring paddle 37. The drive transmission gear 39 provided on the shaft part 48 is engaged with a drive shaft of the motor 40. A drive gear part 39a provided at one end of the shaft part 48 is engaged with the paddle drive gear 38. A projecting portion 41 that rotates integrally with the shaft part 48 is provided at the other end of the shaft part 48.

The rotation speed of the projecting portion 41 is detected (measured) by a photosensor 42 as the rotation speeds of the stirring paddle 37 and the motor 40. The photosensor 42 is included in a rotation speed detector. The photosensor 42 includes, for example, a light emitting part and a light receiving part to detect the projecting portion 41. The projecting portion 41 extends between the light emitting part and the light receiving part of the photosensor 42. The shaft part 48 is rotatable integrally with the drive transmission gear 39, the drive gear part 39a, and the projecting portion 41. The rotation of the motor 40 is transmitted to the shaft part 48 via the drive transmission gear 39. The projecting portion 41 of the rotating shaft part 48 blocks light emitted from the light emitting part of the photosensor 42 toward the light receiving part and thus the rotation number and speed of the shaft part 48 are detected based on the length of the projecting portion 41 and a time period during which the light is blocked. Since the rotation of the shaft part 48 is transmitted to the paddle drive gear 38 and the stirring paddle 37 via the drive gear part 39a, the rotation number and speed of the stirring paddle 37 may be detected by the photosensor 42.

A driving force of the motor 40 is transmitted from the drive transmission gear 39 of the shaft part 48 to the paddle drive gear 38 via the driving gear part 39a, thereby rotating the stirring paddle 37. The drive transmission gear 39 is urged toward the drive gear part 39a by a cylindrical coil spring. In a state in which the rotation of the shaft part 48 stops, the drive transmission gear 39 is thrusted along the shaft part 48 and thus is detachable from the drive shaft of the motor 40.

As the amount of waste toner in the waste toner box 36 increases, a load torque on the paddles 37b of the stirring paddle 37 increases. When the waste toner box 36 is full and the load torque on the paddles 37b of the stirring paddle 37 exceeds a predetermined level, the rotation of the stirring paddle 37 stops. When the rotation of the stirring paddle 37 stops, the rotation of the shaft part 48 engaged with the paddle drive gear 38 by the drive gear part 39a stops.

While the shaft part 48 is stopped, the drive transmission gear 39 engaged with the drive shaft of the motor 40 slides due to a driving force of the motor 40 and an elastic force of the cylindrical coil spring while being guided by the shaft part 48. The rotation of the shaft part 48 is stopped by the sliding of the drive transmission gear 39. The rotation of the projecting portion 41 stops due to the stopping of the rotation of the shaft part 48 and is detected by the photosensor 42. Thus, it is possible to detect the full level of the waste toner box 36. The full level of the waste toner box 36 of the waste toner is displayed on a display unit 46 of the image forming apparatus 10.

The waste toner box 36 includes one or more waste toner collection ports, for example, three waste toner collection ports 36a, 36b, and 36c to collect the waste toner. The waste toner is stored in the waste toner box 36 by the waste toner collection mechanism 27 through the waste toner collection ports 36a, 36b, and 36c. Alternatively, five waste toner collection ports may be provided, corresponding to the intermediate transfer belt cleaner 25 and the photoconductive drum cleaners 33Y, 33M, 33C, and 33K.

The waste toner collected in the waste toner box 36 is accumulated in a mountain shape under each of the waste toner collection ports 36a, 36b, and 36c. The stirring paddle 37 stirs and levels the waste toner such that the waste toner collected in the waste toner box 36 is at the same height. The stirring paddle 37 has not only a function of stirring but also a function of transferring waste toner to the full level detection and drive mechanism 28. When a large amount of waste toner is accumulated in the waste toner box 36, the stirring paddle 37 presses and hardens the waste toner.

The waste toner box 36 may be separated from the image forming apparatus 10 by separating the paddle drive gear 38 from the drive gear part 39a of the shaft part 48 when the stirring paddle 37 is stopped. Then, a new empty waste toner box 36 may be attached.

A number of rotations of the stirring paddle 37 are appropriately set according to image printing and adjustment operations. In the image forming apparatus 10 according to the present embodiment, the number of rotations of the stirring paddle 37 is controlled by replacing the number of rotations with a rotation time of the stirring paddle 37.

However, when the number of rotations of the stirring paddle 37 is not sufficient compared to a predetermined rotation time (which may be also referred to as a set rotation time), the stirring and transfer of the waste toner are not sufficient. In this case, the waste toner collection ports 36a, 36b, and 36c of the waste toner box 36 may clog. Then, the waste toner is not sufficiently discharged from the inside of the photoconductive drum cleaners 33Y, 33M, 33C, and 33K and the intermediate transfer belt cleaner 25 and thus clogging occurs. When the insides of the photoconductive drum cleaners 33Y, 33M, 33C, and 33K and the intermediate transfer belt cleaner 25 are clogged with the waste toner, problems such as a failure of the image forming apparatus 10 may occur.

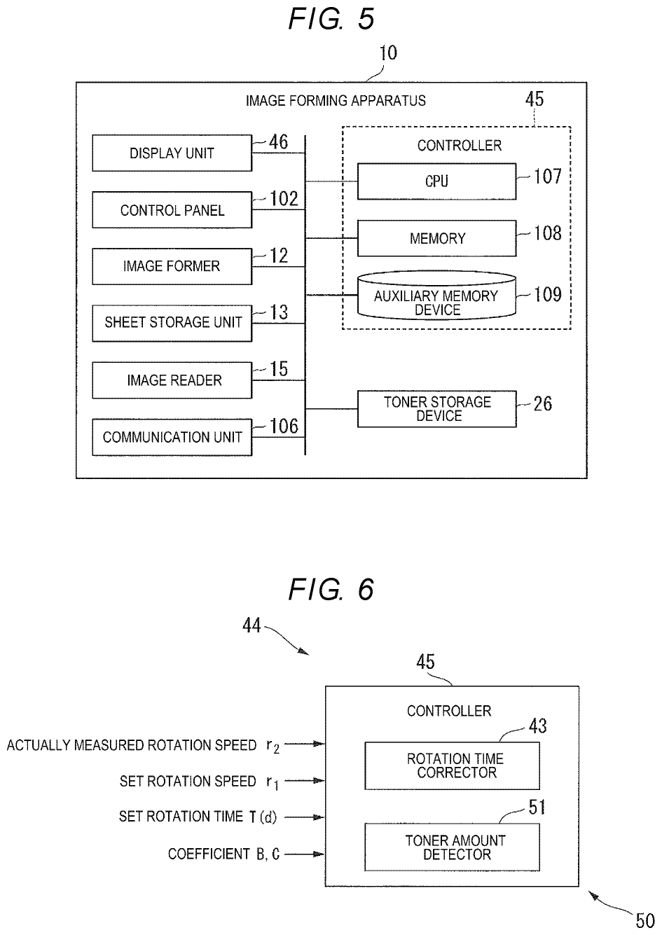

Incidentally, when the number of rotations of the stirring paddle 37 is excessive compared to the predetermined rotation time, an increase in the load torque of the stirring paddle 37 may accelerate. In this case, it is determined that the waste toner box 36 is full even when the amount of waste toner stored in the waste toner box 36 is small. A need to exchange the waste toner box 36 is displayed on the display unit 46 of the image forming apparatus 10 illustrated in FIG. 5.

Generally, in the image forming apparatus 10, a DC brush motor is often used as the motor 40 which is a driving source of the stirring paddle 37. A rotation speed of the DC brush motor may vary due to the structure thereof. Further, the torque of the stirring paddle 37 changes according to the amount of waste toner stored in the waste toner box 36. Thus, the rotation speed of the motor 40 also changes. Even if the set rotation time is determined according to the appropriate number of rotations of the stirring paddle 37, the speed and number of rotations may change due to factors mentioned above, such as the type of the motor 40 and a change in the amount of the waste toner.

The image forming apparatus 10 according to the present embodiment includes a rotation time correction device 44 to correct the set rotation time of the stirring paddle 37. The rotation time correction device 44 obtains a rotation time according to a rotation speed by correcting set rotation times of the stirring paddle 37 and the motor 40 based on a predetermined rotation speed and a measured rotation speed. The rotation speed of the motor 40 may be measured at arbitrary intervals. For example, the rotation speed of the motor 40 may be measured once or twice a day or more.

FIGS. 5 and 6 are diagrams illustrating specific examples of a functional configuration of an image forming apparatus 10 of the embodiment.

The image forming apparatus 10 includes a central processing unit (CPU) 107, a memory 108, an auxiliary memory device 109, and the like which are connected via a bus, and executes a program. The image forming apparatus 10 functions as an apparatus including the display unit 46, a control panel 102, the image former 12, the sheet storage unit 13, the image reader 15, and a communication unit 106 through execution of a program.

The communication unit 106 includes a communication interface to connect the image forming apparatus 10 to an external device. The communication unit 106 communicates with the external device via the communication interface.

The auxiliary memory device 109 is configured using a storage device such as a magnetic hard disk device or a semiconductor storage device. The auxiliary memory device 109 stores information.

The CPU 107 functions as a controller 45 by executing programs stored in the memory 108 and the auxiliary memory device 109. The controller 45 controls an operation of each functional unit of the image forming apparatus 10.

Referring to FIG. 6, an example of the rotation time correction device 44 installed in the controller 45 will be described.

The rotation time correction device 44 includes a rotation time corrector 43 in the controller 45. Information of a set rotation speed r₁ and a set rotation time T(d) of the stirring paddle 37 set in advance is input to the rotation time corrector 43. The rotation time, such as T(d), is a time period for the stirring paddle 37 to remain active once the stirring paddle 37 is actuated. Furthermore, information of an actually measured rotation speed r₂ measured by the photosensor 42 is input to the rotation time corrector 43. The rotation time corrector 43 calculates a corrected rotation time T (f) by Equation (1) below, and outputs it to the motor 40.

First, a correction coefficient p is set based on the set rotation speed r₁ of the stirring paddle 37 and the actually measured rotation speed r₂ of the stirring paddle 37 measured at an arbitrary timing by the photosensor 42 as follows:

p=r₁/r₂

The rotation time T (f) of the stirring paddle 37 (the motor 40) which is corrected using the correction coefficient p may be calculated by Equation (1) below.

T(f)=p×T(d) (1)

When the actually measured rotation speed r₂ of the stirring paddle 37 is measured by the photosensor 42, the actually measured rotation speed r₂ is measured after the motor 40 is started and rotates normally. For example, the motor 40 is not stably driven when the image forming apparatus 10 is powered on or is restarted after a sleep state. The actually measured rotation speed r₂ of the motor 40 is measured by the photosensor 42 after a predetermined time period has elapsed, an unstable operation is ended, and the motor 40 has reached a normal rotation state.

The normal rotation state should be understood as a state, in which a variation of the rotation speed of the stirring paddle 37 (the motor 40) falls within a predetermined ratio or numerical range. Alternatively, the normal rotation state should be understood to mean that a time period or an operation state in which the stirring paddle 37 may be unstable is determined beforehand and rotation speeds therein is excluded from detection targets.

Alternatively, the actually measured rotation speed r₂ of the motor 40 is measured after switching to a normal operation even in cases such as when a cover of the device main body 11 of the image forming apparatus 10 is opened or closed while the cover is opened and closed, when an image is aligned on the intermediate transfer belt 20, when a density of an image is adjusted, or when a refresh operation is performed.

When correcting the rotation time T(f) of the stirring paddle 37, a rotation speed immediately before the correction of the set rotation time T(d) is preferably measured as the actually measured rotation speed r₂. Alternatively, the correction coefficient p is preferably obtained by measuring the actually measured rotation speed r₂ a plurality of times, including a previously measured rotation speed r₂. Accordingly, a more accurately corrected rotation time T(f) may be obtained.

Alternatively, the correction coefficient p may be obtained using one or more actually measured rotation speeds r₂ detected at a stage before a previous rotation speed r₂.

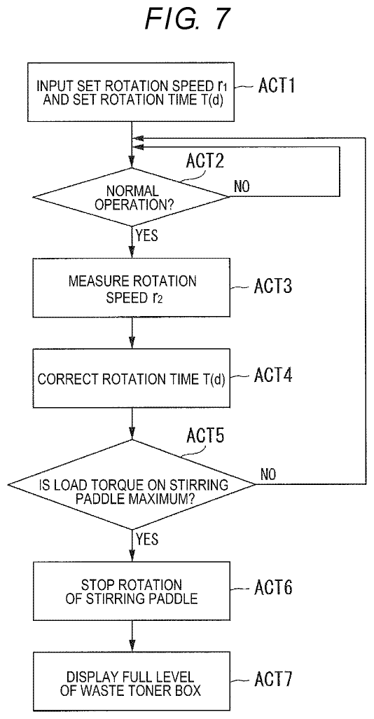

The toner storage device 26 of the image forming apparatus 10 according to the present embodiment has the above-described configuration. An operation of the toner storage device 26 will be described with reference to FIG. 7.

In the image forming apparatus 10, toner images on the photoconductive drums 30Y, 30M, 30C, and 30K to which exposure light is emitted from the exposure device 17 are primarily transferred onto the intermediate transfer belt 20. In this case, part of the toner remains on the photoconductive drums 30Y, 30M, 30C, and 30K as transfer residual toner. The transfer residual toner is removed by the photoconductive drum cleaners 33Y, 33M, 33C, and 33K respectively, and collected in the toner storage device 26 by the waste toner collection mechanism 27.

In the intermediate transfer belt 20, the primarily transferred toner images are secondarily transferred to the sheet P by the sheet transfer device 21. Transfer residual toner remaining on the intermediate transfer belt 20 is removed by the intermediate transfer belt cleaner 25 and collected in the toner storage device 26 by the waste toner collection mechanism 27.

In the toner storage device 26, the waste toner is piled up in a mountain shape respectively by being collected in the waste toner box 36 via the waste toner collection ports 36a, 36b, and 36c. The waste toner is stirred and leveled by rotating the stirring paddle 37 by driving the motor 40. Thereafter, the waste toner is transferred to the full level detection and drive mechanism 28 by the stirring paddle 37, and is hardened by pressing.

In the rotation time correction device 44, the set rotation speed r₁ and the set rotation time T(d) of the stirring paddle 37 and the motor 40 are set according to an image printing or an adjustment operation. The set rotation speed r₁ and the set rotation time T(d) are input beforehand to the rotation time corrector 43 of the controller 45 (ACT1).

In the present embodiment, for example, a DC brush motor is used as the motor 40 and thus rotation speed may vary. Further, a torque of the stirring paddle 37 varies depending on the amount of the waste toner in the waste toner box 36 and thus the rotation speed of the motor 40 may be also variable.

In the toner storage device 26, whether the motor 40 is in a normal operation state is determined (ACT 2), and an actually measured rotation speed r₂ of the motor 40 is measured by the photosensor 42 (ACT 3). A rotation time of the motor 40 is corrected to the rotation time T (f) by Equation (1) above, based on the set rotation speed r₁, the actually measured rotation speed r₂, and the set rotation time T (d) (ACT 4).

When the actually measured rotation speed r₂ of the motor 40 is lower than the set rotation speed r₁, the rotation time T (f) is corrected to be longer than the set rotation time T (d). Therefore, an insufficient number of rotations of the stirring paddle 37 are compensated for, and the waste toner may be sufficiently stirred and transferred. The waste toner is discharged from the inside of the photoconductive drum cleaners 33Y, 33M, 33C, and 33K and the intermediate transfer belt cleaner 25 into the waste toner box 36 through the waste toner collection mechanism 27. Accordingly, the photoconductive drum cleaners 33Y, 33M, 33C, and 33K and the intermediate transfer belt cleaner 25 may be prevented from clogging or malfunctioning.

When the actually measured rotation speed r₂ of the motor 40 is higher than the set rotation speed r₁, the rotation time T (f) is changed to be shorter than the set rotation time T (d). Therefore, the waste toner is prevented from being excessively stirred and transferred by the stirring paddle 37 rotating at high speed, and a sharp increase in the load torque is suppressed. Accordingly, a determination that the waste toner box 36 is full of the waste toner is not advanced. Thus, it is possible to prevent the waste toner box 36 from being exchanged in a state in which the amount of the waste toner in the waste toner box 36 is less than a capacity of the waste toner box 36.

Even if the rotation speed of the motor 40 which is a DC brush motor is variable, an appropriate number of rotations may be set according to a change in the actually measured rotation speed r₂ by correcting the set rotation time T (d). This operation may be repeatedly performed by the rotation time correction device 44 and the full level detection and drive mechanism 28 of the toner storage device 26 (ACTS).

When a desired amount of waste toner is collected in the waste toner box 36, the rotation of the stirring paddle 37 is stopped due to an increase in the load torque thereof. Then, the paddle drive gear 38 and the drive gear part 39a stop and thus the shaft part 48 also stops. At the same time, the drive transmission gear 39 of the shaft part 48 slides due to the elastic force of the cylindrical coil spring. The photosensor 42 senses non-rotation of the projecting portion 41 provided on the shaft part 48 (ACT6).

Thereafter, the controller 45 detects that the waste toner box 36 is full of the waste toner and displays the full level of the waste toner box 36 on the display unit 46 of the image forming apparatus 10 (ACT7).

The toner storage device 26 of the image forming apparatus 10 according to the present embodiment is capable of correcting the set rotation time T(d) to the rotation time T(f) which is an optimum time length by detecting the actually measured rotation speed r₂ of the stirring paddle 37.

When the rotation speed of the stirring paddle 37 is low, the waste toner may be sufficiently stirred and transferred by increasing the rotation time T(f) to increase the number of rotations of the stirring paddle 37. Then, the waste toner may be discharged from the inside of each cleaner into the waste toner box 36, so that clogging or failure of each cleaner may be prevented. When the rotation speed of the stirring paddle 37 is excessive, the number of rotations may be reduced by decreasing the rotation time T (f) to be less than the set rotation time T(d). Accordingly, it is possible to appropriately determine whether the waste toner storage box 36 is full of waste toner.

Furthermore, even if the rotation speed of the motor 40 is variable, an appropriate number of rotations may be set according to a change in the actually measured rotation speed r₂ by changing the rotation speed T(f).

An image forming apparatus 10 according to a second embodiment will be described below, in which parts and members that are the same as those of the above-described first embodiment will be described using same reference numerals.

A toner storage device 26 according to the second embodiment includes a toner amount detection device 50 configured to estimate an amount of waste toner in a waste toner box 36 according to a change in the rotation speed of a stirring paddle 37. The toner amount detection device 50 detects a full level of waste toner in the waste toner box 36 and displays the full level of waste toner on a display unit 46 of the image forming apparatus 10.

The toner amount detection device 50 will be described with reference to FIG. 6 below.

The toner amount detection device 50 includes a toner amount detector 51 in a controller 45. An initial rotation speed r₂(s) of a motor 40 measured by a photosensor 42 and a rotation speed r₂(d) of the motor 40 measured subsequently after the start of use of the motor 40 are input to the toner amount detector 51. The toner amount detector 51 determines whether the amount of waste toner collected from the waste toner box 36 reaches a predetermined storage amount close to a full level, based on Equation (2) or (3) below. For example, whether the amount of stored waste toner is, for example, 80% of the predetermined storage amount close to the full level is determined. When it is determined that the amount of the stored waste toner is 80% or more of the predetermined storage amount, a result of the determination is displayed on the display unit 46.

In the toner amount detector 51, for example, a storage ratio of the amount of the waste toner is calculated by a first waste toner amount estimator or a second waste toner amount estimator.

The first waste toner amount estimator will be described below. An initial rotation speed of the stirring paddle 37 (the motor 40) after the exchange of a new waste toner box 36 is detected as the initial rotation speed r₂(s) by the photosensor 42. Thereafter, the rotation speed r₂(d) after the start of use of the image forming apparatus 10 is subsequently detected.

It is determined whether a near-full rate, that is, the storage ratio of the amount of the waste toner, is 80% or more, based on a change ratio of the rotation speed r₂(d) with respect to the initial rotation speed r₂(s) or a ratio of magnitude of the rotation speed r₂(d) and the initial rotation speed r₂(s). The rotation speed r₂(d) is preferably a rotation speed immediately before the amount of the waste toner is determined. The rotation speed r₂(s) is a first rotation speed, and the rotation speed r₂(d) is a second rotation speed.

Detection of the near-full rate of the amount of the waste toner is estimated by Equation (2) below.

r₂(d)/r₂(s)≤B (2)

Here, B represents a coefficient corresponding to a threshold value b at which the ratio of the amount of the waste toner in the waste toner box 36 is 80%. The threshold value b is an average value of values obtained through a plurality of sample tests.

It is determined that when a result of Equation (2) is less than or equal to B, the amount of the waste toner in the waste toner box 36 is 80% or more. Then, a suggestion regarding the exchange of the waste toner box 36 is displayed on the display unit 46 of the image forming apparatus 10.

The second waste toner amount estimator estimates the near-full rate of the amount of the waste toner according to Equation (3) below.

r₂(s)−r₂(d)≥C (3)

Here, C represents a coefficient corresponding to a threshold c at which the ratio of the amount of the waste toner in the waste toner box 36 is 80%. The threshold value c is an average value of values obtained through a plurality of sample tests.

When a result of Expression (3) is equal to or greater than C, it is determined that the amount of the waste toner in the waste toner box 36 is 80% or more. Then, a suggestion regarding the exchange of the waste toner box 36 is displayed on the display unit 46 of the image forming apparatus 10.

The predetermined storage amount which is a threshold value of the amount of the waste toner for detection of the near-full rate of the waste toner in the waste toner box 36 by the toner amount detection device 50 is not limited to 80%. As a storage amount immediately before the waste toner box 36 is full of the waste toner, another appropriate ratio may be selected as a threshold value.

In the toner storage device 26 of the image forming apparatus 10 according to the second embodiment, the waste toner is discharged from the intermediate transfer belt cleaner 25 and the photoconductive drum cleaners 33Y, 33M, 33C, and 33K. The waste toner is supplied to the waste toner box 36 through the waste toner collection mechanism 27. When the amount of the waste toner stored in the waste toner box 36 increases, the load torque of the rotating stirring paddle 37 increases. The rotation speed of the motor 40 detected by the photosensor 42 and the projecting portion 41 decreases.

The initial rotation speed r₂(s) and a previous rotation speed r₂(d) are input to the toner amount detector 51 of the controller 45 illustrated in FIGS. 5 and 6. The toner amount detector 51 detects a change in the amount of the waste toner according to Equation (2) or (3).

The toner amount detector 51 detects, through a calculation, that the amount of the waste toner in the waste toner box 36 reaches the predetermined storage amount close to the full level, for example, a threshold value of 80% or more. A result of the calculation is displayed on the display unit 46 of the image forming apparatus 10.

In the toner storage device 26 of the image forming apparatus 10 according to the second embodiment, the toner amount detector 51 may determine, through the calculation, whether the amount of the waste toner is close to the full level, based on a change in the rotation speed. A result of the determination may be displayed on the display unit 46 of the image forming apparatus 10.

The rotation time correction device 44 of the toner storage device 26 according to the embodiment has been described above with respect to waste toner to be collected without being used among toner supplied for printing, adjustment, or the like performed by the image forming apparatus 10. However, the toner storage device 26 according to the embodiment is not limited to a case of the image forming apparatus 10. The toner storage device 26 is applicable to various types of toner storage devices. Furthermore, toner to be processed by the toner storage device 26 may be toner other than waste toner.

In addition, the toner amount detection device 50 according to the second embodiment is not limited to a case of the image forming apparatus 10. The toner amount detection device 50 is applicable to various types of toner storage devices and toner other than waste toner.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. An image forming apparatus comprising:
a waste toner box collecting unused toner in the image forming apparatus;
a stirring member configured to stir the toner in the waste toner box;
a rotation speed detector configured to detect a rotation speed of the stirring member;
a rotation time corrector configured to correct a set number of rotations of the stirring member based on a relationship between the rotation speed detected by the rotation speed detector and a set rotation speed of the stirring member; and
a toner amount detector configured to detect whether an amount of the toner in the waste toner box reaches a predetermined amount close to a full level, based on a change in the rotation speed of the stirring member detected by the rotation speed detector, wherein the toner amount detector detects whether the amount of the toner in the waste toner box is near the full level, based on a relationship between a threshold value at which a predetermined amount of the toner in the waste toner box is near the full level and a ratio or a difference between a first rotation speed detected by the rotation speed detector and a second rotation speed detected by the rotation speed detector immediately after detecting of the first rotation speed.

2. The image forming apparatus according to claim 1, wherein the set number of rotations is calculated based on a set rotation time.

3. The image forming apparatus according to claim 1, further comprising a toner amount detector configured to detect whether an amount of the toner in the waste toner box reaches a predetermined amount after the rotation speed detector detects a change in the rotation speed of the stirring member.

4. The image forming apparatus according to claim 1, wherein:
the rotation speed is detected in a normal rotation state, the normal rotation state being:
(1) a state in which a variation of the rotation speed of the stirring member falls within a predetermined ratio or numerical range when the rotation speed detector detects the rotation speed of the stirring member; or
(2) a state outside a time period or operation state in which the rotation speed of the stirring member is predetermined to be unstable, and
wherein the normal rotation state is achieved during at least one of powering on after a sleep state, alignment of an image, detection of image density, when opening or closing a cover, or performing a refresh operation.

5. The image forming apparatus according to claim 1, wherein when a set rotation time of the stirring member is corrected by the rotation time corrector, the set rotation time is corrected based on one or more rotation speeds detected by the rotation speed detector.

6. The image forming apparatus according to claim 1, wherein when the detected rotation speed is lower than the set rotation speed, the set rotation time is corrected to be increased.

7. The image forming apparatus according to claim 1, wherein when the detected rotation speed is higher than the set rotation speed, the set rotation time is corrected to be reduced.

8-9. (canceled)

10. The image forming apparatus according to claim 1, wherein when the toner amount detector detects that the amount of the toner in the waste toner box is near the full level, a result thereof is displayed on a display unit of the image forming apparatus.

11. A method for controlling a stirring paddle in a waste toner box for collecting waste toner, the method comprising:
providing a set rotation speed for the stirring paddle, the set rotation speed corresponding to a set rotation time;
detecting a rotation speed of the stirring paddle;
determining a corrected rotation time based on the detected rotation speed of the stirring paddle; wherein determining the corrected rotation time based on the detected rotation speed of the stirring paddle comprises multiplying the set rotation time with a ratio between the set rotation speed and the detected rotation speed.

12. (canceled)

13. The method of claim 11, wherein detecting the rotation speed further comprises:
detecting an initial rotation speed;
detecting a subsequent rotation speed; and
determining a capacity state of the waste toner box based on the detected initial rotation speed and the subsequent rotation speed.

14. The method of claim 13, wherein determining the capacity state of the waste toner box comprises comparing a ratio or a difference between the subsequent rotation speed and the initial rotation speed to a threshold value.

15. The method of claim 14, further comprising displaying the determined capacity state on a display unit for a replacement notification of the waste toner box.

16. A waste toner controller comprising a rotation time corrector, the waste toner controller configured to control operations of an image forming device, wherein the rotation time corrector receives input including:
a set rotation speed of a stirring paddle in a waste toner box;
a set rotation time corresponding to the set rotation speed, wherein the set rotation speed and the set rotation time are stored in a memory of the waste toner controller; and
a measured rotation speed detected by a sensor monitoring the stirring paddle; and
wherein the rotation time corrector determines and outputs a corrected rotation time based on the measured rotation speed, and
wherein the corrected rotation time is determined by multiplying the set rotation time with a ratio between the set rotation speed and the measured rotation speed.

17. (canceled)

18. The waste toner controller of claim 16, further comprising a toner amount detector, wherein the toner amount detector is configured to:
detect an initial rotation speed;
detect a subsequent rotation speed; and
determine a capacity state of the waste toner box based on the detected initial rotation speed and the subsequent rotation speed.

19. The waste toner controller of claim 18, wherein the toner amount detector receives a capacity threshold value and determines the capacity state of the waste toner box by comparing a ratio or a difference between the subsequent rotation speed and the initial rotation speed to the threshold value.

20. The waste toner controller of claim 19, wherein the waste toner controller is connected with a display unit in the image forming device, and wherein the waste toner controller, upon determination performed by the toner amount detector, provides the determined capacity state for displaying on the display unit.
